(19) United States
(12) Patent Application Publication
(10) Pub. No.: US 2008/0264886 A1
(43) Pub. Date: Oct. 30, 2008

(54) Telescopic Camera Crane

(76) Inventors: Peter Adamiec, Opole (PL); Keith Edwards, Surrey (GB)

Correspondence Address: BLANK ROME LLP, 600 NEW HAMPSHIRE AVENUE, N.W., WASHINGTON, DC, 20037, US

(21) Appl. No.: 11/792,588

(22) PCT Filed: Dec. 9, 2005
(86) PCT No.: PCT/GB2005/004762

§ 371 Date: Mar. 19, 2008

(30) Foreign Application Priority Data
Dec. 10, 2004 (GB) 0427111.0

(51) Int. Cl. B66C 23/76; B66F 11/04

(52) U.S. Cl. 212/196

(57) ABSTRACT

A telescopic crane for supporting a camera or the like comprising a telescopic support, with at least one arm (4) extending outward from one end (2), a counterweight means (6) extending from the other end (3) of the support which moves relative to the or each arm (4) to maintain balance of the crane, wherein the arm (4) and counterweight (6) are driven by a drive belt (10).

The present invention relates to a telescopic camera crane.

Telescopic cranes are extensively used in television and the film industry for manipulating cameras when filming. The cranes allow a camera mounted on a telescopic arm to be moved relative to a shot. Conventionally, telescopic cranes have a counterweight system to balance any extension or retraction of the telescopic arm.

Conventionally, a telescopic arm is moved using a system of wire ropes and pulleys. Wire ropes have a high breaking strain which is sufficient to accommodate for the dead weight of the counterbalance. However, the breaking strain of wire ropes is not sufficient to allow for the high velocities and subsequently high inertia of the arm which are sometimes encountered when the camera crane is maneuvered. Breaking of the wire ropes is very hazardous to an audience or crew on set beneath the crane and could cause severe damage or destruction of camera equipment carried by the crane. Conventional rope and pulley systems are also dangerous because at speed, the rope can jump off the pulley.

The present invention sets out to overcome, or at least alleviate, the problems described above by providing a telescopic camera crane of improved strength and stability which has an improved safety performance even when the camera is moved rapidly.

The present invention provides a telescopic crane for supporting a camera or the like comprising a telescopic support, with at least one arm extending outward from one end, a counterweight means extending from the other end of the support which moves relative to the or each arm to maintain balance of the crane, wherein the arm and counterweight are driven by a drive belt.

By being driven by a belt the crane can safely support a fast-moving camera. By using a single belt to transport the arm forward and the counterweight rearward the crane is able to balance quickly and accurately.

It is understood that the telescopic camera crane can support a camera or like audio or visual equipment including but not limited to cameras or microphones.

Preferably, the telescopic camera crane comprises a plurality of arms extending from a front end of the crane wherein each arm is driven by an auxiliary belt.

By providing a plurality of arms the crane is able to extend to a range of lengths and reach inaccessible corners. By driving each arm using an auxiliary belt the crane is made safer and easier to manufacture. A modular system makes the crane easier to dismantle and reassemble in a small space and reduces “down time” when the crane is transported.

Preferably, the main belt and/or auxiliary drive belts are grooved.

By providing grooved belts the telescopic crane is less likely to slip during extension or retraction of the or each arm.

Preferably the counterweight means comprises an adjustable weight supporting carriage.

By providing an adjustable weight supporting carriage the telescopic crane can be adjusted during use according to the number of arms and belts included.

Preferably, at least one arm is made from aluminium.

An arm made from aluminium is strong to withstand use and lightweight to reduce the load on the main and auxiliary belts.

Preferably the at least one arm and at least one drive belt are contained within a housing.

By providing a housing all of the moving parts are contained and the telescopic camera crane has a sleeker appearance and is safer to use.

The invention will now be described by way of example with reference to the accompanying diagrammatic drawings, in which:

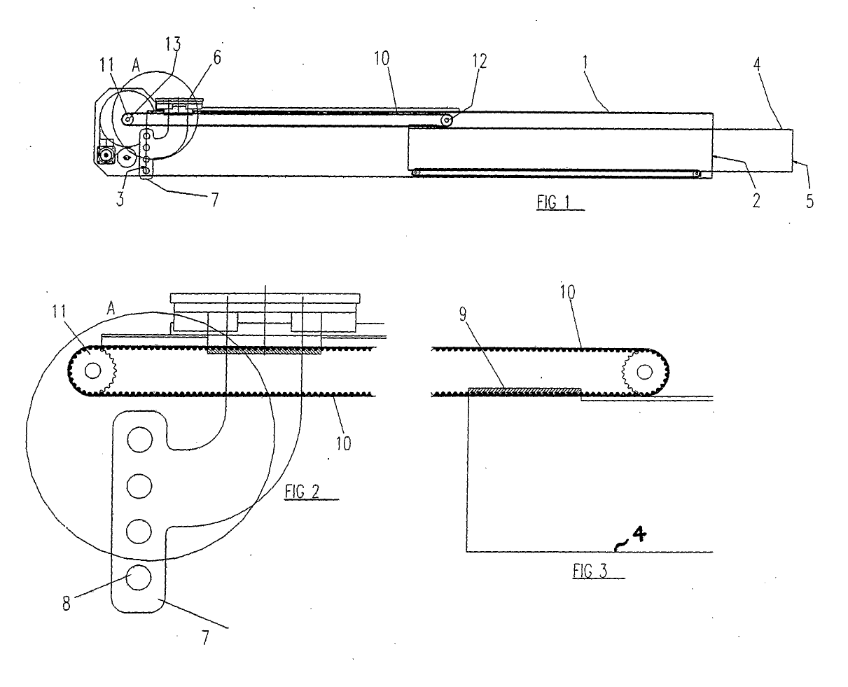

FIG. 1 is a side view of a telescopic camera crane in an extended configuration in accordance with the present invention;

FIG. 2 is an enlarged view of the counterweight means of the telescopic camera crane shown in region A of FIG. 1;

FIG. 3 is an enlarged view of a main belt drive of the telescopic camera crane of FIG. 1;

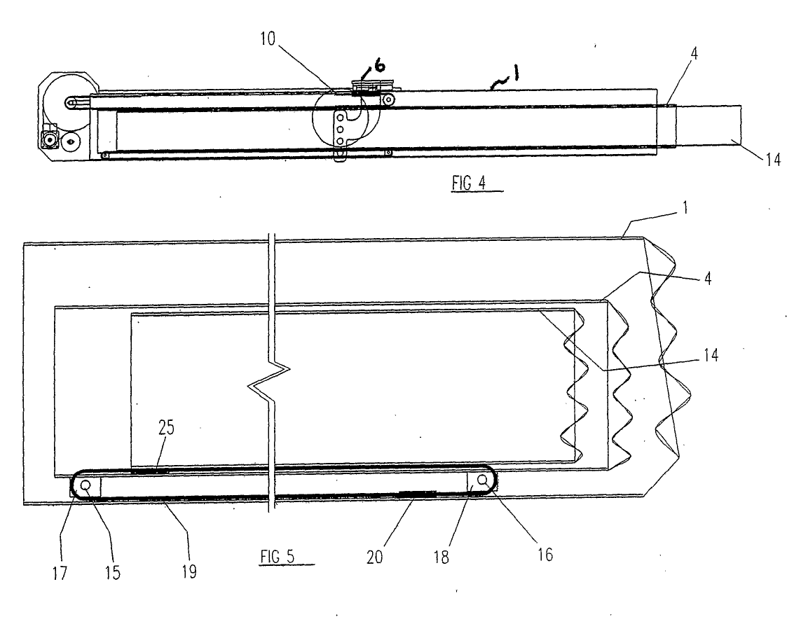

FIG. 4 is a side view of a telescopic camera crane of a preferred embodiment of the present invention, showing a telescopic camera crane with a plurality of arms in a retracted configuration;

FIG. 5 is an enlarged view of the auxiliary belt and arm arrangement of the telescopic camera crane of FIG. 4; and

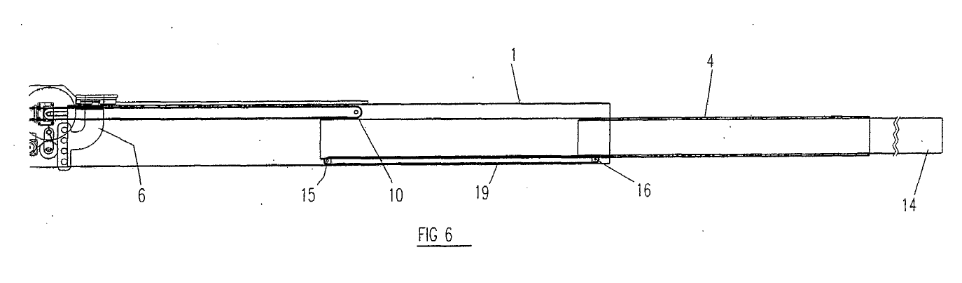

FIG. 6 is a side view of the telescopic camera crane of FIG. 4, showing the plurality of arms in an extended configuration.

Referring first to FIG. 1, the telescopic camera crane comprises a housing 1 with a forward end 2 and a rearward end 3. A first arm 4 extends from the forward end 2 of the housing 1. The forward end 2 of the arm 4 comprises a cradle 5 on which a camera (not shown) can rest. A counterweight system 6 extends from the rearward end 3 of the housing 1. As shown in FIG. 2, the counterweight system 6 comprises a weight supporting rail 7 which hangs perpendicular to the length of the housing 1. The weight supporting rail 7 comprises attachment means to which weights 8 can be attached.

The first arm 4 is telescopically extendable and retractable. The first arm 4 is clamped via clamping means 9 to a main drive belt 10. The upper surface of the first arm 4 runs along the lower surface of the main drive belt 10. The main drive belt 10 passes around a cog 11 attached to the rearward end 3 of the arm 4. The main drive belt 10 is held under tension and stretched around a second cog 12. As shown in FIG. 3, the drive belt 10 is grooved and held securely around the cogs 11, 12. The first and second cogs 11, 12 are rotatable around respective first and second axles 13 which are adjustable to ensure that the belt 10 is always held under tension. The counterweight system 6 is clamped to the main drive belt 10.

When the first arm 4 is telescopically extended the main drive belt 10 moves around the two cogs 11, 12 to simultaneously adjust the position of the counterweight system 6 and maintain the balance of the telescopic camera crane.

In use, the midpoint of the housing 1 would be pivotally mounted on a “dolly” (not shown) which can be moved along a rolling track to allow movement of the entire telescopic crane. Alternatively the crane could be suspended from above or mounted on another support system.

In an alternative embodiment of the present invention, as shown in FIG. 4, in addition to the first arm 4 and main drive belt 10 of FIG. 1, a second arm 14 is telescopically mounted within the first arm 4. The second arm 14 is telescopically extendable and retractable.

As shown in FIG. 5, an auxiliary drive belt 19 is grooved and held securely under tension around free running cogs 15, 16. The first arm 4 is attached to the auxiliary belt 19 by blocks 17 and 18. The auxiliary belt 19 is attached to the housing 1 by clamp 20. The second arm 14 is attached to auxiliary drive belt 19 by clamp 25.

With the first arm 4 extended forward of the housing 1, the main drive belt 10 moves counter clockwise around cogs 11 and 12. The main drive belt 10 simultaneously moves the counterweight system 6. Auxiliary drive belt 19 simultaneously moves around cogs 15 and 16 to extend second arm 14 forward of the first arm 4.

All arms 4, 14 telescopically extend and retract guided by precision ground rails and ball bearing blocks.

Additional arms may be added to the telescopic crane. A similar arrangement of auxiliary drive belts and free running cogs would be necessary for the additional arms.

The above described embodiment has been given by way of example only, and the skilled reader will naturally appreciate that many variations could be made thereto without departing from the scope of the present invention.

1. A telescopic crane for supporting a camera or the like comprising a support, a plurality of drive belts and a plurality of arms extending telescopically outward from one end, a counterweight means which is moveable relative to the arms to maintain balance of the crane, wherein a first arm and the counterweight means are attached to and driveable by a single drive belt and each further arm or arms is driven by a respective auxiliary drive belt.

2. A telescopic camera crane according to claim 1 wherein the drive belt and/or the at least one auxiliary belt is grooved.

3. A telescopic camera crane according to claim 1 wherein the counterweight means comprises an adjustable weight supporting carriage.

4. A telescopic camera crane according to claim 1 wherein the or each arm is made from aluminium.

5. A telescopic camera crane according to claim 1 wherein the or each arm and the or each drive belt are contained within a housing.

6. A telescopic camera crane substantially as hereinbefore described or referred to in FIGS. 1 to 6.
